(19) United States
(12) Patent Application Publication
(10) Pub. No.: US 2014/0313093 A1
(43) Pub. Date: Oct. 23, 2014

(54) HORIZONTALLY POLARIZED OMNI-DIRECTIONAL ANTENNA APPARATUS AND METHOD

(71) Applicant: Telefonaktiebolaget L M Ericsson, Stockholm (SE)

(72) Inventors: Roland A. Smith, Nepean (CA); Peter Frank, Stittsville (CA); Jim Wight, Ottawa (CA)

(21) Appl. No.: 13/871,443

(22) Filed: Apr. 26, 2013

Related U.S. Application Data
(60) Provisional application No. 61/812,885, filed on Apr. 17, 2013.

(51) Int. Cl. H01Q 21/24

(52) U.S. Cl. CPC H01Q 21/24
USPC 343/795

(57) ABSTRACT

An Alford antenna array having at least three driven elements disposed on a substrate, a first portion of each driven element being disposed on one side of the substrate, and a second portion of said each driven element being disposed on a second side of the substrate. At least one of the driven elements has a bent-dipole Alford loop coupled to two feed points and has an acute-angle dipole feed point and acute-angle loaded ends. In other embodiments, the driven elements may comprise any combination of bent-dipoles and/or folded-and-bent dipoles. In further embodiments, six dipoles are concentrically disposed about a central point, where three of the dipoles may operate at a different frequency than the other three dipoles.

This application claims priority to U.S. provisional Patent Application No. 61/812,885, filed Apr. 17, 2013, the entire contents of which are incorporated herein by reference.

### BACKGROUND OF THE INVENTION

1. Field of the Invention

The present invention relates to wireless communication and omni-directional antennas. More specifically, the present invention relates to omni-directional antennas for wireless local area network (“WLAN”), Wi-Fi, and pico-cellular wireless communications systems, including IEEE 802.11 systems. In particular, the present invention provides an innovative Alford antenna array using more than two elements of folded dipoles, which has particular utility as an antenna array for Wi-Fi and multiple-input and multiple-output (MIMO) telecommunications systems.

2. Description of the Related Art

As is known, an Alford loop antenna was designed to radiate horizontally polarized waves for guiding aircraft in the horizontal plane. The original Alford loop antenna (U.S. Pat. No. 2,283,897, filed on Apr. 26, 1939) consisted of a two horizontal half-wave dipoles arranged at right angles to each other. This patent was original in describing the first antenna to exclusively radiate in the horizontally polarization.

U.S. Pat. Nos. 2,283,897 and 2,372,651 to Alford disclose general information about omni-directional antennas and are incorporated herein by reference. U.S. Pat. No. 5,751,252 to Phillips discloses an omni-directional antenna of reduced size and is also incorporated herein by reference.

A problem with existing four segment (2 dipole) Alford loop antennas is that their physical size becomes impractically small at the higher frequencies (e.g., greater than 2 GHz). At and above the cellular band the diameter of a practical four segment Alford loop is about 38 mm. The result is an antenna with segment lengths and segment coupling components that are too small to be tuned practically or adjusted by a human operator.

Another problem with Alford loop antenna arrays is that they produce high spatial ripple. Attempts to reduce ripple will also reduce the input impedance.

U.S. Patent Publication No. 2007/0069968 to Moller attempts to cure some of the above-noted deficiencies of Alford antenna arrays. Moller (also incorporated herein by reference) discloses an omni-directional loop antenna for radiating an electromagnetic signal from a signal source and includes a differential feed and at least six radiating elements. The differential feed generates a first signal feed and a second signal feed. The radiating elements include at least three evenly-numbered radiating elements and at least three oddly-numbered elements. Each of the evenly-numbered radiating elements is coupled to the first signal feed and each of the oddly-numbered radiating elements is coupled to the second signal feed. Each of the oddly-numbered radiating elements is reactively coupled to two different ones of the evenly-numbered radiating elements. No two of the first radiating elements are reactively coupled to a same pair of second radiating elements. The dipoles are formed by radiating elements on both sides of the substrate.

The fundamental teaching of Moller is six radiating elements, each including a first end and a spaced-apart second end. Since the ends are spaced apart, Moller is keenly focused on the capacitively-coupled dipole arms (second part). Moller uses a dipole with a cut in it to create a capacitively-tuned element. Dipoles have an impedance of roughly 72 ohms, so three parallel dipoles would have an impedance of 24 ohms. As will be developed more fully below, the present invention, in certain embodiments, uses folded dipoles with an impedance of 300 ohms each, so that three parallel folded dipoles would have an impedance of 100 ohms. A transformer circuit is preferably used to match to the RF 50 ohms line.

With the proliferation of wireless local area networks or WLANs, there has been an increase in requirements to find cost effective means to deploy small, efficient access points having MIMO capabilities. In such systems, conventional omni-directional antennas would enable greater coverage, but would require a very large footprint.

### SUMMARY OF THE INVENTION

The present invention provides method and apparatus to enable a omni-directional antenna array which has: (1) reduced size—which relates to lower cost; (2) an even omni-directional pattern with less ripple; (3) allowance for directors for higher gain; and (4) allowance to mix/match elements to be dipoles and folded dipoles.

In one aspect, the invention provides an Alford antenna array having at least three driven elements disposed on a substrate, a first portion of each driven element being disposed on one side of the substrate, and a second portion of said each driven element being disposed on a second side of the substrate. At least one of the driven elements having a bent-dipole Alford loop coupled to two feed points and having an acute-angle dipole feed point and acute-angle loaded ends. In other embodiments, the driven elements can have an obtuse-angle dipole feed point. In further embodiments, at least one of the driven elements comprises a rounded-and-folded-dipole Alford loop.

In another aspect, the invention provides an Alford antenna array having a first antenna array with at least three driven elements disposed on a substrate; a first portion of each driven element being disposed on one side of the substrate, and a second portion of each driven element being disposed on a second side of the substrate. Each of the driven elements having a rounded-and-folded-dipole Alford loop coupled to two first feed points; the first antenna array operating at a first frequency. A second antenna array with at least three second driven elements disposed on the substrate; a first portion of each second driven element being disposed on the one side of the substrate, and a second portion of each second driven element being disposed on the second side of the substrate. Each of the second driven elements comprising a rounded-and-folded-dipole Alford loop coupled to two second feed points; the second antenna array operating at a second frequency different than the first frequency.

In yet another aspect, the invention provides a method of providing an omni-directional Alford antenna array, comprising: (i) disposing at least three driven elements on two sides of the same substrate such that one portion of each driven element is on one side of the substrate and a second portion of each driven element is on a second side of said substrate; and (ii) providing at least one of the driven elements with a folded and bent dipole.

The means of wired connectivity coupled into the module may be selected from the group consisting of DOCSIS, DSL, ADSL, HDSL, VDSL, EPON, GPON, Optical Ethernet, T1, and E1. The antenna may be configured to enable wide-band multi-carrier operation. The at least one wireless transceiver may include a plurality of wireless transceivers, and the at least one antenna element may include a plurality of antenna elements, each of the plurality of antenna elements corresponding to a different one of the plurality of wireless transceivers.

### BRIEF DESCRIPTION OF THE DRAWINGS

FIG. 1 is a schematic top view of a three-element, bent-dipole antenna according to a preferred embodiment.

FIG. 2 is a schematic top view of a three-element, bent and folded-dipole antenna array according to another preferred embodiment.

FIG. 3 is a schematic top view of a three-element, combined folded-dipole and bent-dipole antenna array according to yet another preferred embodiment.

FIG. 4 is a schematic top view of a three-element, folded and rounded dipole antenna array according to a further preferred embodiment.

FIG. 5 is a schematic top view of a four-element, folded and rounded dipole antenna array according to another preferred embodiment.

FIG. 6 is a schematic top view of a four-element, folded and rounded dipole antenna array, with rounded directors, or bent directors, or straight directors, according to, according to yet another preferred embodiment.

FIG. 7 is a schematic top view of two, three-element, folded and rounded dipole antenna arrays, according to a further preferred embodiment.

FIG. 8 is a schematic top view of another embodiment of two, three-element, folded and rounded dipole antenna arrays, according to the present invention.

### DETAILED DESCRIPTION OF THE INVENTION

Preferred embodiments of the present invention will be described hereinbelow with reference to the accompanying drawings. In the following description, well-known functions or constructions are not described in detail because they may obscure the invention in unnecessary detail. The present invention relates to an innovative Alford antenna array that may be coupled to, or integrated with, an Access Point (AP) or other communication device to enhance Wi-Fi and pico-cellular operation with multiple clients in an interference-limited environment. The present invention may find particular utility in strand-mount APs for Tier One cable operators building small-cell networks, such as the BelAir 100NE. Such APs preferably incorporate dual 802.11n-2009 Wi-Fi radios with 3×3 MIMO and 3 spatial stream support. Each AP preferably integrates a DOCSIS® 3.0, Euro-DOCSIS 3.0, or Japanese-DOCSIS 3.0 cable modem.

For this disclosure, the following terms and definitions shall apply:

The terms “IEEE 802.11” and “802.11” refer to a set of standards for implementing WLAN computer communication in the 2.4, 3.6 and 5 GHz frequency bands, the set of standards being maintained by the IEEE LAN/MAN Standards Committee (IEEE 802).

The terms “communicate” and “communicating” as used herein include both conveying data from a source to a destination, and delivering data to a communications medium, system, channel, network, device, wire, cable, fiber, circuit, and/or link to be conveyed to a destination; the term “communication” as used herein means data so conveyed or delivered. The term “communications” as used herein includes one or more of a communications medium, system, channel, network, device, wire, cable, fiber, circuit, and/or link.

The term “omnidirectional antenna” as used herein means an antenna that radiates radio wave power uniformly in all directions within a preferred plane, with the radiated power decreasing with elevation angle above or below the plane, dropping to zero on the antenna's axis, thereby producing a doughnut-shaped radiation pattern.

The term “processor” as used herein means processing devices, apparatus, programs, circuits, components, systems, and subsystems, whether implemented in hardware, tangibly-embodied software or both, and whether or not programmable. The term “processor” as used herein includes, but is not limited to, one or more computers, hardwired circuits, signal modifying devices and systems, devices, and machines for controlling systems, central processing units, programmable devices, and systems, field-programmable gate arrays, application-specific integrated circuits, systems on a chip, systems comprised of discrete elements and/or circuits, state machines, virtual machines, data processors, processing facilities, and combinations of any of the foregoing.

The terms “storage” and “data storage” and “memory” as used herein mean one or more data storage devices, apparatus, programs, circuits, components, systems, subsystems, locations, and storage media serving to retain data, whether on a temporary or permanent basis, and to provide such retained data. The terms “storage” and “data storage” and “memory” as used herein include, but are not limited to, hard disks, solid state drives, flash memory, DRAM, RAM, ROM, tape cartridges, and any other medium capable of storing computer-readable data.

The present invention provides a horizontally polarized, omni-antenna with high gain, low spatial ripple, in a planar (flat) design. The preferred embodiments feature folded dipoles and folded, rounded, or straight directors. Preferably, the folded dipoles have an impedance of 300 ohms each, so that three parallel folded dipoles have an impedance of 100 ohms. A transformer circuit is used to match to the RF 50 ohms line.

The folded dipole also gives a highly uniform current distribution across the outward facing portion of the element. The present embodiments preferably have three locations where the back-to-back dipoles fold in on each other, causing a drop in current density. The ripple is quite small, approximately 0.4 dB. In contrast, the Moller device appears to have six locations where the current density will vary, and three of these locations have a small tail so their ripple will be significantly higher. The present invention also contemplates the use of mixed folded or non-folded dipoles with the advantage of minimizing impedance mismatch.

The use of directors and/or reflectors in certain embodiments helps to improve the gain of the antenna. As is known, an antenna may have a reflector and one or more directors. Such a design operates on the basis of electromagnetic interaction between these parasitic elements and the driven element. The reflector element is typically slightly longer than the driven element, whereas the directors are typically somewhat shorter. This design achieves a substantial increase in the antenna's directionality and gain, compared to a simple dipole.

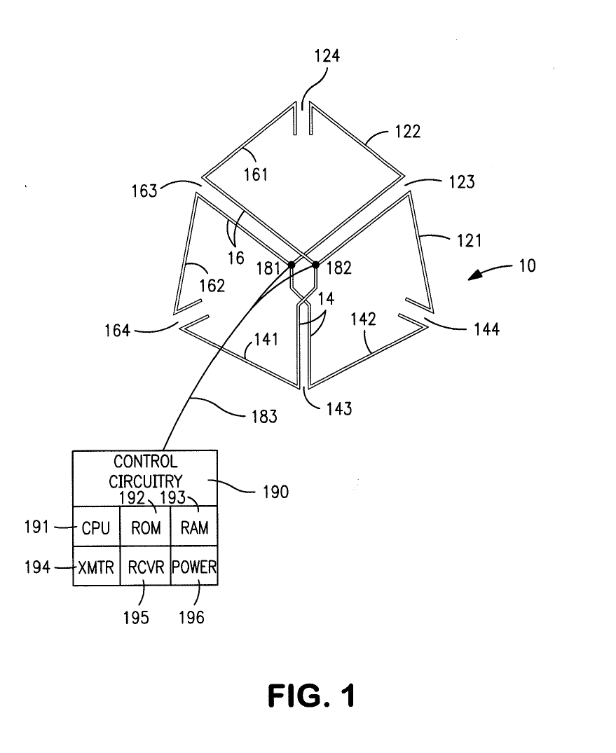

In FIG. 1, a three-driven-element Alford omni-directional antenna array 10 comprises a first driven element (dipole) 12, a second driven element 14, and a third driven element 16. Each driven element is disposed on opposite sides of a substrate, in FIG. 1, the side 1 elements 121, 141, and 161, are on the top of the substrate, and the side 2 elements 122, 142, and 162 are on the bottom. Preferably, the driven elements comprise copper (or other suitable metal such as gold, titanium, etc.) deposited on a printed circuit board (PCB) substrate by known PCB-forming techniques such as photo-etching, chemical vapor deposition, etc. The driven elements of FIG. 1 are shaped with bent dipole feed points 123, 143, and 163, and with transmission line loaded ends 124, 144, and 164. In the FIG. 1 embodiment, both the feed points and loaded transmission ends are shaped with acute angles. The array of FIG. 1 is useful with 2.4 Ghz cellular telephone signals, and the array will likely be 1-5 inches in diameter, more preferably, 2-4 inches in diameter, and most preferably 3 inches in diameter; although any size may be used depending on the signals to be transmitted/received. As presently conceived, each antenna array according to the present invention will be mounted in a Access Point (AP) enclosure, together with the AP circuitry 190. However, for Multiple Input Multiple Output (MIMO) systems two, three, or more antenna arrays may be mounted in each AP enclosure. The antenna arrays may be mounted in different enclosure corners, at different heights, to avoid signal interference. It is also possible that the two or more antenna arrays be stacked on top of one another, again to avoid interference.

One advantage of the three-driven-element Alford antenna array depicted in FIG. 1 is that the current distribution around the outer perimeter of the array is more uniform than in the prior art, leading to reduced spatial ripple and higher effective gain. In particular, the present embodiment provides six ripple sections around the perimeter, but the ripple amplitude is lessened, producing a more uniform signal. A beam-strength diagram of the FIG. 1 embodiment would show the three signal lobes extending over the dipole feed points 123, 143, and 163, with lower signal-strength areas over the loaded ends 124, 144, and 164.

The feed points 181 and 182 are preferably coupled to an RF cable 183, which is coupled to control circuitry 190 having at least one processor 191, ROM 192, RAM 193, transmitter 194, receiver 195 (or, equivalently a transceiver), power supply 196, and other not-shown elements such as interfaces, splitters, heating/cooling structures, etc.

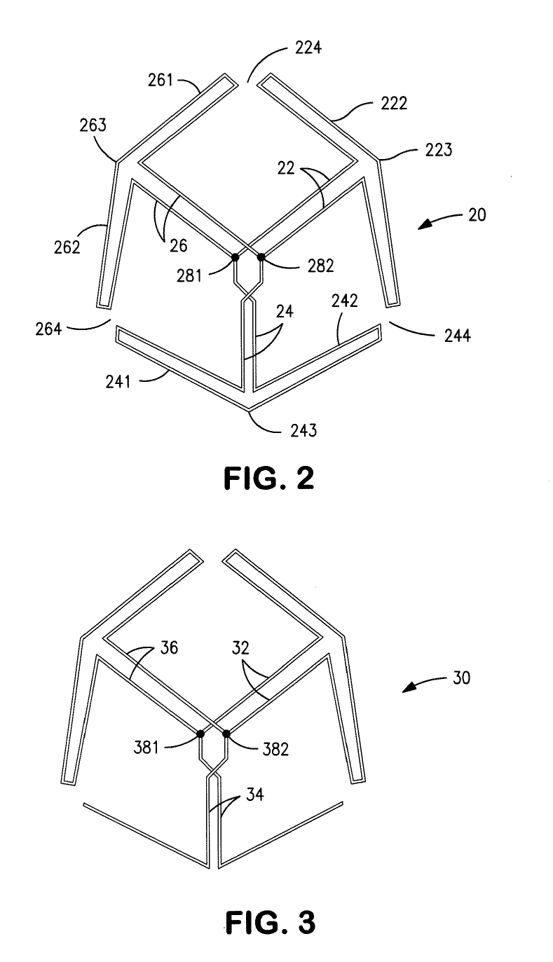

FIG. 2 shows a three-element, folded-dipole antenna array according to another preferred embodiment. A folded dipole is a half-wave dipole with an additional wire connecting its two ends. If the additional wire has the same diameter and cross-section as the dipole, two nearly identical radiating currents are generated. The resulting far-field emission pattern is nearly identical to the one for the single-wire dipole described above; however, at resonance its input (feed point) impedance is four times the radiation resistance of a single-wire dipole. This is because for a fixed amount of power, the total radiating current is equal to twice the current in each wire and thus equal to twice the current at the feed point. Like in FIG. 1, the dipoles are bent, but in FIG. 2, the dipoles are also folded, leading to a reduces footprint on the PCB: each array having a diameter of 1-2 inches, more preferably 1.5 inches. This smaller size and folded-dipole arrangement produces even lower ripple, trending close to a 1:1 ratio of high-current to low-current around the periphery of the array. The three-element Alford omni antenna array 20 comprises a first driven element 22, a second driven element 24, and a third driven element 26. Each driven element is disposed on opposite sides of a substrate, in FIG. 2, the side 1 elements 221, 241, and 261, are on the top of the substrate, and the side 2 elements 222, 242, and 262 are on the bottom. Alford feed points 281 and 282 are preferably driven by circuitry coupled via an RF cable. The driven elements of FIG. 2 are shaped with bent dipole feed points 223, 243, and 263. In the FIG. 2 embodiment, the feed points are shaped with obtuse angles.

In FIG. 3, a three-element, combined folded-dipole and bent-dipole antenna array 30 is shown on a planar PCB substrate. While FIG. 3 depicts one bent-dipole 34 and two folded dipoles 32 and 36, the array 30 could comprise two bent-dipoles and one folded-dipole. The use of combined bent and folded-dipoles allows for more accurate impedance-matching of the array. Alford feed points 381 and 382 are used to drive the array, as described above.

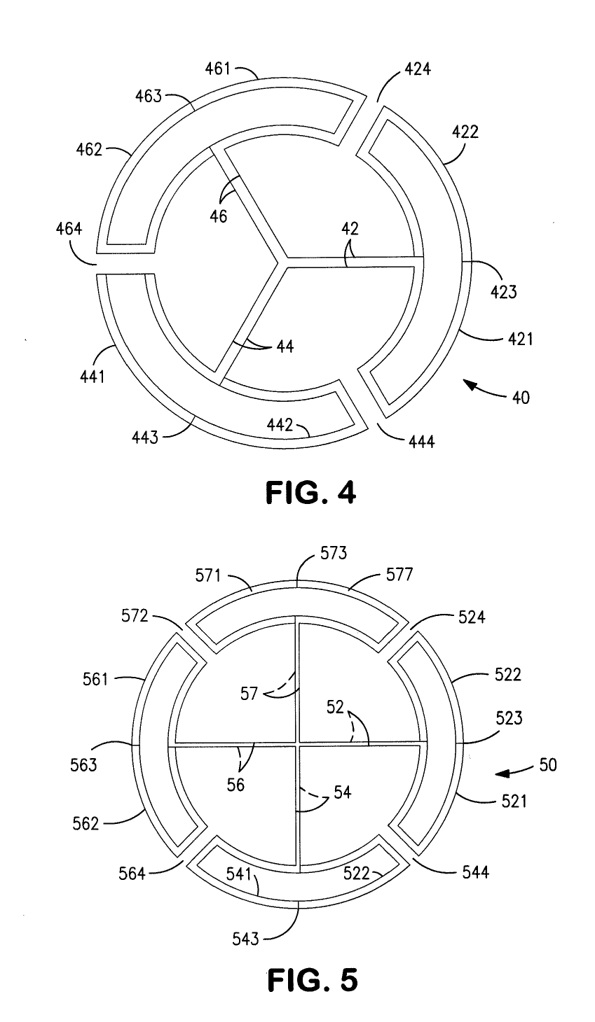

FIG. 4 is a top view of a three-element, folded and rounded dipole antenna array 40 according to a most preferred embodiment. As with FIG. 1, each dipole 42, 44, and 46 is disposed on opposite sides of a planar PCB substrate, with the side 1 elements 421, 441, and 461 on the top of the substrate, and the side 2 elements 422, 442, and 462 on the bottom. In FIG. 4, the “spoke” elements of the bottom layer dipole elements are not shown, as they are occluded in FIG. 4 by the top layer “spokes.” The driven elements of FIG. 4 are shaped with bent and rounded dipoles. The dipole feed points 423, 443, and 463, are shown, together with with transmission line loaded ends 424, 444, and 464. The Alford feed points are not shown in FIG. 4, but are centrally-disposed as in the other Figs.

FIG. 5 depicts a four-element, folded and rounded dipole antenna array 50 according to another embodiment. Similar to FIG. 4, each dipole 52, 54, 56, and 57 is disposed on opposite sides of the PCB substrate, with the top side elements 521, 541, 561, and 577 and bottom side elements 522, 542, 562, and 571. In FIG. 5, the “spoke” elements of the bottom layer dipole elements are not shown, as they are covered by the top layer “spokes” in the Fig. The driven elements of FIG. 5 are shaped with bent and rounded dipoles. The dipole feed points 523, 543, 563, and 573 are shown, together with transmission line loaded ends 524, 544, 564, and 572. The Alford feed points are not shown, but are centrally-disposed. Of course, any number of dipoles could be formed on the planar substrate, depending upon the IEEE 82.11 signal to be transmitted/received, and the particular use for which the antenna array is designed. The FIG. 5 embodiment will provide a higher gain than the FIG. 4 embodiment.

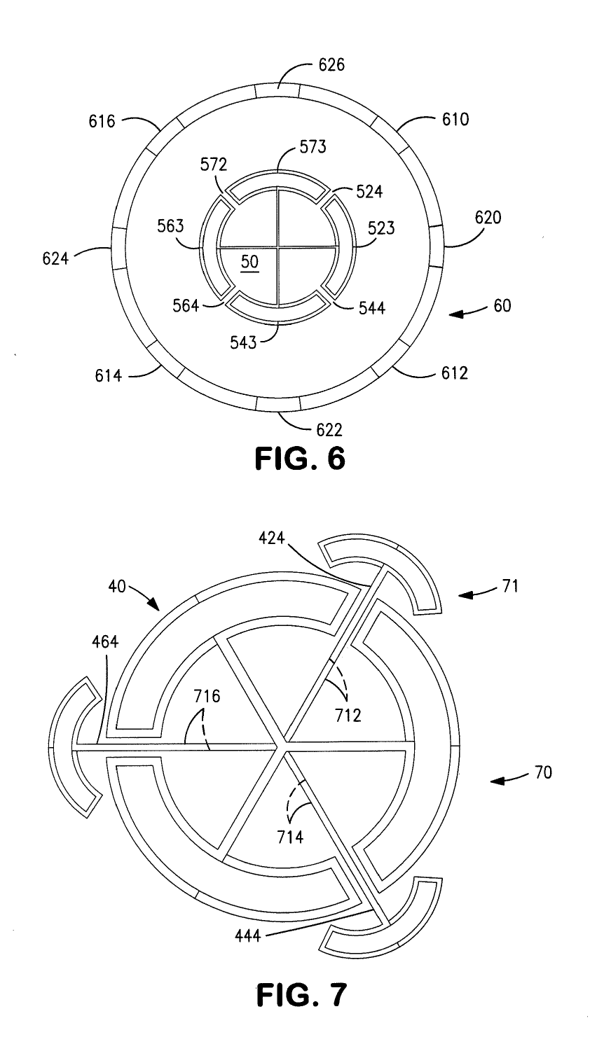

FIG. 6 shows the four-element, folded and rounded dipole antenna array 50 shown in FIG. 5, but with rounded directors 60 coaxially disposed outward of the array 50, according to yet another preferred embodiment. The directors are preferably comprised of copper (or other suitable materials) formed on the top and bottom sides of the PCB substrate with known PCB-forming techniques. The top-side director 610 is disposed outward of the loaded end 524, the top-side director 612 is disposed outward of the loaded end 544, the top-side director 614 is disposed outward of the loaded end 564, and top-side director 616 is disposed outward of the loaded end 572. In similar fashion, the bottom-side director 620 is disposed outward of the feed point 523, the bottom-side director 622 is disposed outward of the feed point 543, the bottom-side director 624 is disposed outward of the feed point 563, and the bottom-side director 626 is disposed outward of the feed point 573. Note that the top and bottom-side directors have similar arc lengths, but are overlapped by most of their lengths, as shown in FIG. 6.

FIG. 7 depicts two, three-element, folded and rounded dipole antenna arrays 70 for dual-mode use, according to a further preferred embodiment. The arrays 70 comprise the three-element array 40 of FIG. 4, having an array 71 coaxially disposed outward of the array 40. In use, the array 40 may transmit/receive 2.4 GHz signals, while the array 71 may transmit/receive 5.0 GHz signals. As array 40 was described in detail above, no further description will be provided here. The array 71 comprises dipoles 712, 714, and 716. As with FIG. 5, the bottom-side “spokes” of these dipoles are not shown in the Figure, for clarity. The dipole 712 extends through the loaded end 424, the dipole 714 extends through the loaded end 444, and dipole 716 extends through the loaded end 464, as shown. The dipoles 712, 714, and 716 are constructed similarly to those dipoles described above and will not be further described here. It is sufficient to note that the 5 GHz dipoles are smaller, with a sharper curvature suitable to the higher frequency signal.

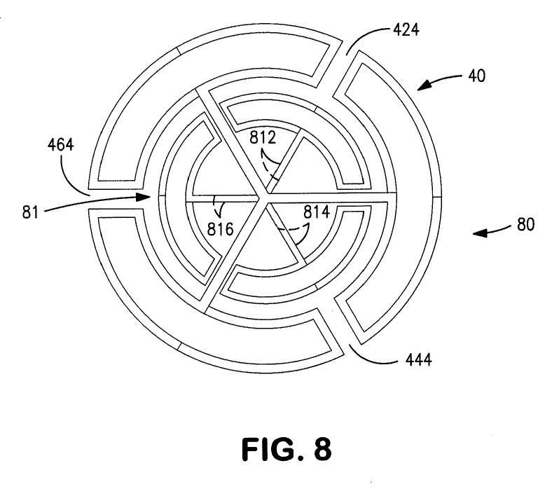

FIG. 8 depicts two, three-element, folded and rounded dipole antenna arrays 80 for dual-mode use, similar to FIG. 7, but with the 5 GHz antenna array 81 disposed coaxially inward of the array 40. Thus, dipole 812 is disposed inward of loaded end 424, the dipole 814 is disposed inward of the loaded end 444, and the dipole 816 is disposed inward of loaded end 464. Again, the construction of the dipoles is similar to that described above and will not be further described here.

In this manner, an innovative antenna system according to a preferred embodiments of the present invention has been designed and field-tested to verify functional operation.

While the foregoing detailed description has described particular preferred embodiments of this invention, it is to be understood that the above description is illustrative only and not limiting of the disclosed invention. While preferred embodiments of the present invention have been shown and described herein, it will be obvious to those skilled in the art that such embodiments are provided by way of example only. Numerous variations, changes, and substitutions will now occur to those skilled in the art without departing from the invention.

What is claimed is:

1. An Alford antenna array, comprising:
at least three driven elements disposed on a substrate, a first portion of each driven element being disposed on one side of said substrate, and a second portion of said each driven element being disposed on a second side of said substrate, at least one of said at least three driven elements comprising a bent-dipole Alford loop coupled to two feed points and having an acute-angle dipole feed point and acute-angle loaded ends.

2. The antenna array according to claim 1, wherein said at least three driven elements comprise two bent-and-folded-dipole Alford loops.

3. The antenna array according to claim 1, wherein said at least three driven elements comprise two bent-dipole Alford loops.

4. The antenna array according to claim 3, wherein said at least three driven elements comprise one bent-and-folded-dipole Alford loop.

5. The antenna array according to claim 1, wherein said at least three driven elements comprise three bent-dipoles.

6. The antenna array according to claim 1, further comprising switch structure disposed on said substrate adjacent the driven elements and configured to drive the antenna array beam.

7. An Alford antenna array, comprising:
at least three driven elements disposed on a substrate, a first portion of each driven element being disposed on one side of said substrate, and a second portion of said each driven element being disposed on a second side of said substrate, at least one of said at least three driven elements comprising a bent-and-folded-dipole Alford loop coupled to feed points and having an obtuse-angle dipole feed point.

8. The antenna array according to claim 7, wherein said at least three driven elements comprise two bent-dipole Alford loops.

9. The antenna array according to claim 7, wherein said at least three driven elements comprise two bent-and-folded-dipole Alford loops.

10. The antenna array according to claim 9, wherein said at least three driven elements comprise one bent-dipole Alford loop.

11. The antenna array according to claim 7, wherein said at least three driven elements comprise three bent-and-folded-dipole Alford loops.

12. The antenna array according to claim 7, further comprising switch structure disposed on said substrate adjacent the driven elements and configured to drive the antenna array beam.

13. The antenna array according to claim 7, further comprising at least one director for each of said at least three driven elements, each director disposed on the same side of the substrate and out-board of the corresponding driven element.

14. An Alford antenna array, comprising:
at least three driven elements disposed on a substrate, a first portion of each driven element being disposed on one side of said substrate, and a second portion of said each driven element being disposed on a second side of said substrate, each of said driven elements comprising a rounded-and-folded-dipole Alford loop coupled to two feed points and having a non-acute-angle dipole feed point.

15. The antenna array according to claim 14, wherein said at least three driven elements comprise four rounded-and-folded-dipole Alford loops.

16. The antenna array according to claim 14, further comprising at least one rounded director for each driven element, the rounded directors being disposed on the same side of said substrate and out-board of the driven elements.

17. An Alford antenna array, comprising:
a first antenna array comprising at least three driven elements disposed on a substrate, a first portion of each driven element being disposed on one side of said substrate, and a second portion of each driven element being disposed on a second side of said substrate, each of said driven elements comprising a rounded-and-folded-dipole Alford loop coupled to two first feed points, said first antenna array operating at a first frequency; and
a second antenna array comprising at least three second driven elements disposed on said substrate, a first portion of each second driven element being disposed on the one side of said substrate, and a second portion of each second driven element being disposed on the second side of said substrate, each of said second driven elements comprising a rounded-and-folded-dipole Alford loop coupled to two second feed points, said second antenna array operating at a second frequency different than said first frequency.

18. The antenna array according to claim 17, wherein the first antenna array and the second antenna array are disposed concentrically about substantially the same point.

19. The antenna array according to claim 18, wherein the first antenna array is disposed outboard of the second antenna array.

20. The antenna array according to claim 18, wherein the first antenna array driven elements are smaller than the second antenna array driven elements.

21. The antenna array according to claim 18, wherein the first antenna array driven elements are larger than the second antenna array driven elements.

22. A method of providing an omni-directional Alford antenna array, comprising:
disposing at least three driven elements on two sides of the same substrate such that one portion of each driven element is on one side of the substrate and a second portion of each driven element is on a second side of said substrate;
providing at least one of said driven elements with a folded and bent dipole.

23. A method of operating an antenna array in a circularly-oriented, at-least-six antenna Alford array disposed on a printed circuit board, each antenna having a driven element, comprising the steps of:
operating a control circuit so as to activate at least one driven element of a first at-least-three-element array, at a first frequency to cause a first beam to be transmitted from the array; and
operating the control circuit so as to activate at least one driven element of a second at-least-three-element array, at a second frequency to cause a second beam to be transmitted from the array, the second frequency being different than the first frequency.
